(19) United States
(12) Patent Application Publication
(10) Pub. No.: US 2010/0096863 A1
(43) Pub. Date: Apr. 22, 2010

(54) MECHANICAL LATCH ASSEMBLY FOR RETRACTABLE SCREEN DOORS AND WINDOWS

(75) Inventor: Peter F. SIEMENS, Abbotsford (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: ALCO VENTURES INC., Langley (CA)

(21) Appl. No.: 12/580,989

(22) Filed: Oct. 16, 2009

Related U.S. Application Data
(60) Provisional application No. 61/106,105, filed on Oct. 16, 2008.

(51) Int. Cl. E05C 9/08; E05C 19/00; E05C 19/06

(52) U.S. Cl. 292/3; 292/2; 292/85

(57) ABSTRACT

A mechanical latch assembly for a retractable door or window system is described. The latch assembly includes a latch subassembly mountable between inner and outer door handles and a catch subassembly mountable on a support surface. When the retractable door or window is adjusted to a fully closed position, the latch and catch subassemblies may be releasably coupled together by engaging a latch and a catch bar. A safety catch may be optionally deployed for maintaining the latch in an engaged position. The latch subassembly may include a pair of rotatable cassettes and a corresponding pair of thumb levers for rotating the cassettes against the bias of a spring to move the latch from the engaged to a disengaged position. The latch may be disposed on one of the rotatable cassettes. The catch assembly may include optional brackets for mounting the catch assembly on a door jamb, pocket door frame, another door handle or other suitable support surface.

### RELATED APPLICATIONS

This application claims the benefit of the priority of U.S. application No. 61/106,105 filed 16 Oct. 2008 and entitled MECHANICAL LATCH ASSEMBLY FOR RETRACTABLE SCREEN DOORS AND WINDOWS, which is hereby incorporated by reference.

### TECHNICAL FIELD

This application relates to a mechanical latch assembly for retractable screen doors and windows.

### BACKGROUND

Most commercially available retractable screen doors use a magnetic latching system. Such magnetic latches are sometimes difficult for elderly or infirm users to easily open. Also, such systems also do not provide any measure of security since they can not be locked in the closed position. In outdoor applications, the metal magnetic components are also prone to gradual corrosion.

Some mechanical latch systems are known in the prior art but they are not commonly used in respect of retractable door and window applications. In the prior art, mechanical latches are typically mortised into an aluminum door extrusion at predetermined locations and are therefore not easily adapted for different door or window configurations.

The need has therefore arisen for a more versatile mechanical latch assembly specifically designed for retractable screen door and window applications. A non-limiting example of such an application is the MIRAGE™ retractable door system sold by the applicant.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

In accordance with the invention, a latch assembly for a retractable door or window closure is provided, the closure having a first handle and a second handle disposed on opposite sides of the closure for moving the closure between retracted and extended positions. The latch assembly includes a (a) latch subassembly disposed between the first and second handles, the latch subassembly comprising (i) a latch disposed on a rotatable cassette, and (ii) at least one lever for actuating rotation of the cassette to move the latch between an engaged and a disengaged position; and (b) a catch subassembly mountable on a support surface for releasably engaging the latch when the closure is in the extended position and the latch is moved to the engaged position.

In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 is a front view of a conventional retractable screen door in a partially extended position.

FIG. 2 is a first perspective, exploded view of the mechanical latch assembly of the present invention showing one embodiment of the latch and catch subassemblies.

FIG. 3 is a perspective, exploded view of the latch subassembly.

FIG. 4 is another perspective, exploded view of the latch subassembly.

FIG. 4(a) is an enlarged perspective view of the safety catch of the latch subassembly.

FIG. 5 is a perspective, exploded view showing embodiments of the catch subassembly, including some alternate mounting brackets.

FIG. 6 is another perspective, enlarged, exploded view of the catch subassembly embodiments of FIG. 5.

FIG. 7 is a further enlarged perspective view of a handle and the latch subassembly.

FIG. 8 is an enlarged, perspective view of a pair of cassettes and a shaft connector of the latch subassembly.

FIG. 9 is an enlarged perspective of the latch subassembly mounted on a door handle for releasably engaging a catch subassembly.

FIG. 10 is a further perspective view of the latch subassembly mounted on opposed door handles for releasably engaging a catch subassembly mounted on a door jamb.

FIG. 11 is an enlarged perspective of the latch subassembly mounted on a door handle for releasably engaging a catch subassembly mounted on another door in a French door application.

FIG. 12 is an enlarged, cut-away view of a spring-loaded cassette of the latch subassembly positionable within a door handle.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

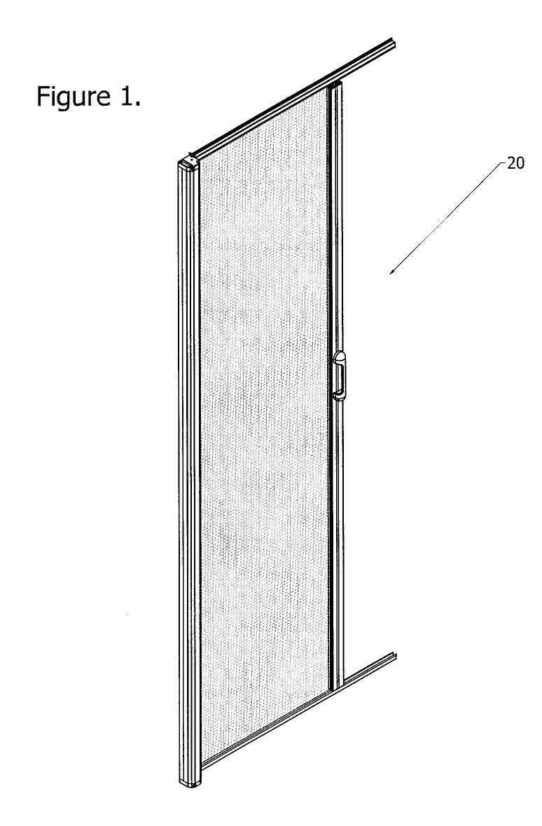

This application relates to a mechanical latch assembly generally designated 10 for a retractable closure, such as a retractable screen door 20 or window adjustable between a retracted and an extended position. A non-limiting example of such a closure is the MIRAGE™ retractable screen door system sold by the applicant, as shown in FIG. 1. As will be appreciated by a person skilled in the art, such doors can be installed to fit many different door applications, including in-swing or out-swing doors, patio doors, pocket doors, entrance doors and French double doors. When not in use, the screen doors retract within a housing and are substantially hidden from view.

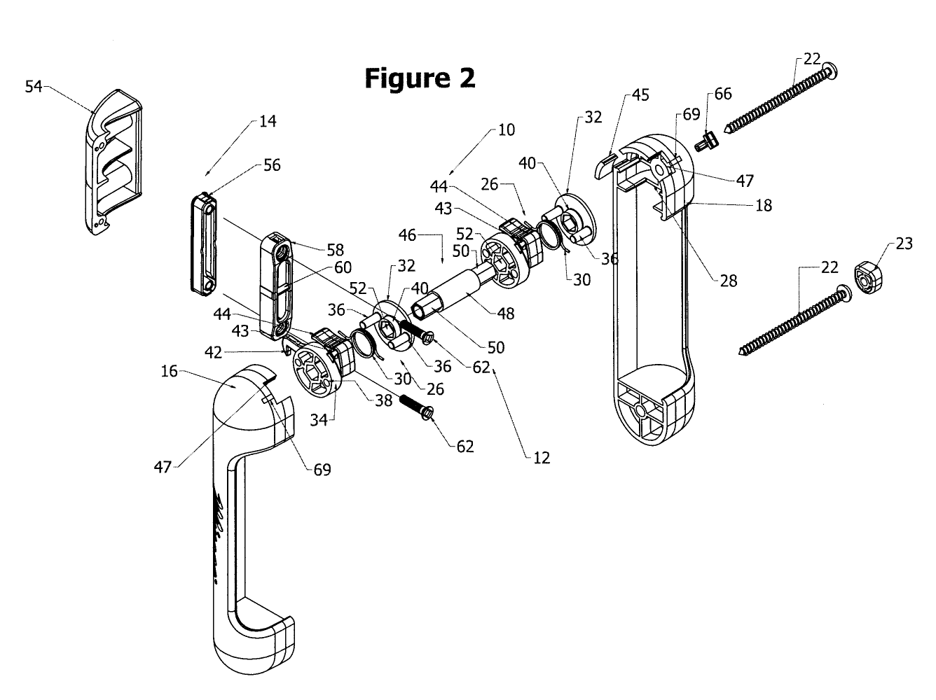

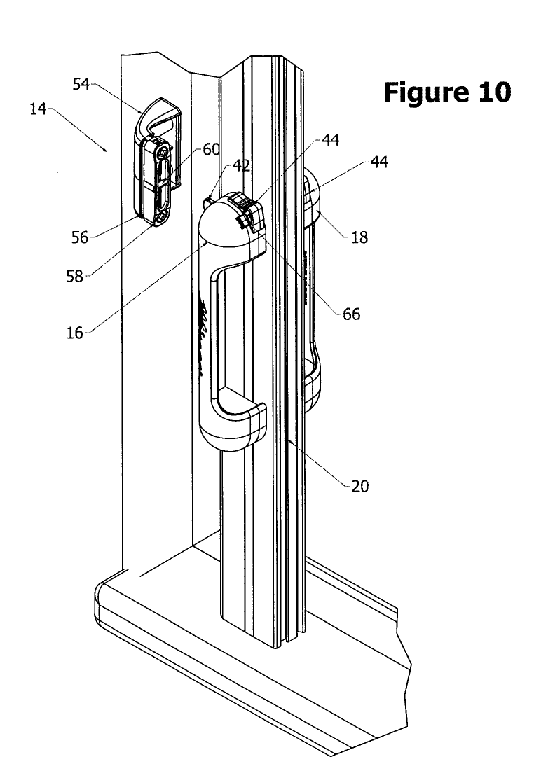

As shown in FIG. 2, latch assembly 10 includes a latch subassembly 12 and a catch subassembly 14. Latch subassembly 12 extends between a first handle 16 and a second handle 18 disposed on opposite sides of door 20. For example, first handle 16 could be disposed on the inner surface of door 20 and second handle 18 could be disposed on the outer surface of door 20 (FIG. 10). As described below, catch subassembly 14 may be disposed on a door jamb or another support surface for coupling to latch subassembly 12 when door 20 is in its extended position.

Handle 16, 18 may be coupled together at the desired location on door 20 by means of fasteners 22, as shown in FIGS. 2-4. The upper fastener 22 also functions as an axle for latch subassembly 12. After each fastener 22 has been inserted, plugs 23 may be inserted in an end portion of a handle 16, 18 to hide the heads of the fasteners 22. In the illustrated embodiment, plugs 23 are insertable into handle 18 only and the threaded end portion of each fastener 22 is received within the other handle 16.

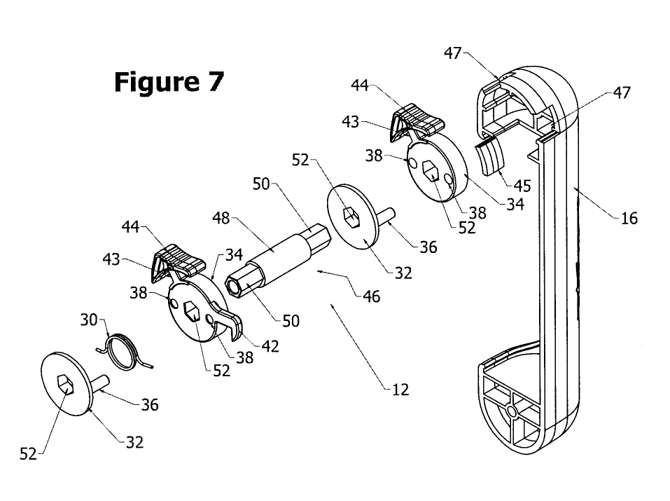

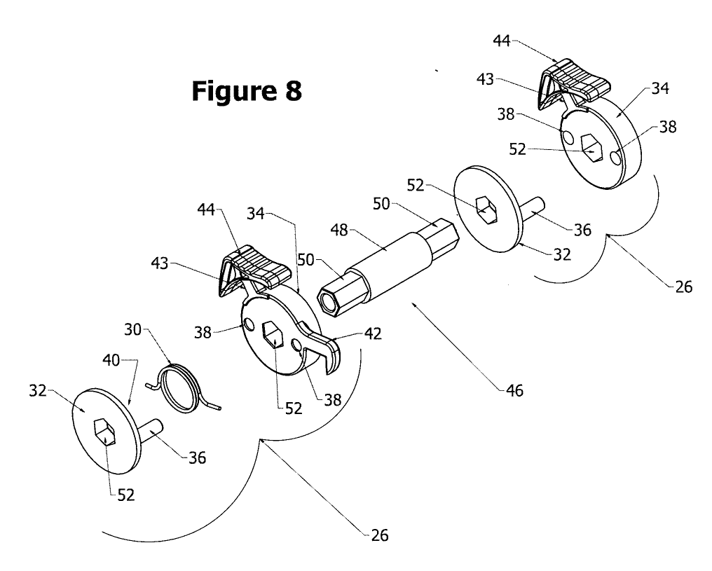

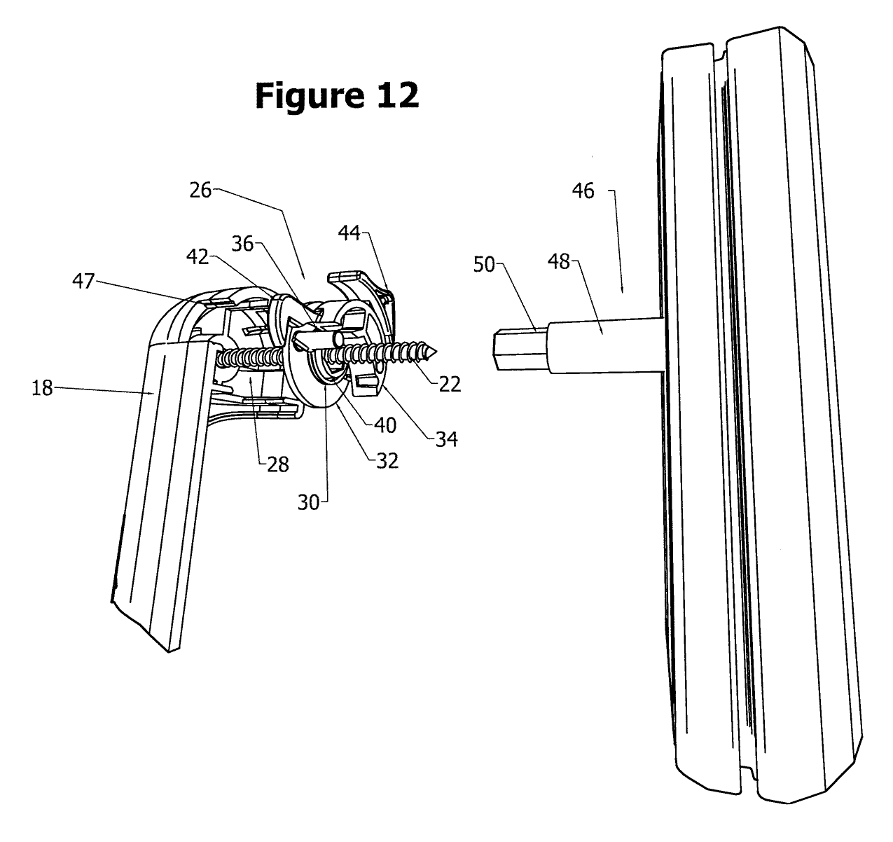

Latch subassembly 12 further includes a pair of cassettes 26 each received within a cavity 28 formed in a respective handle 16, 18. Each cassette 26 comprises a first annular plate 32 and a second annular plate 34 which may be matingly coupled together, as best shown in FIGS. 7 and 8. For example, in the illustrated embodiment, first plate 32 includes a pair of pins 36 which are each received within a mating aperture 38 in second plate 34. At least one of the cassettes 26 comprises a spring 30 which is captured between first plate 32 and second plate 34. First plate 32 includes a rim 40 for receiving spring 30. In one embodiment of the invention, the end portions of spring 30 are each positioned underneath a respective pin 32. As best shown in FIG. 12, one end of spring 30 fits underneath a ledge located within a handle cavity 28 to tension spring 30 when cassette 26 is rotated. Optionally, spring 30 may be tensioned when cassette 26 is rotated in either direction.

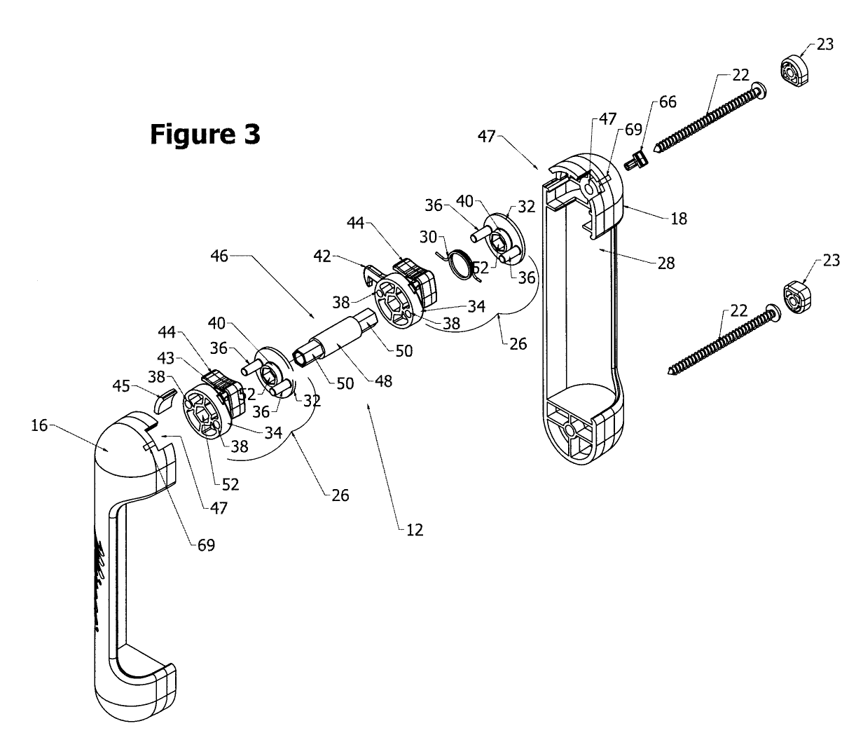

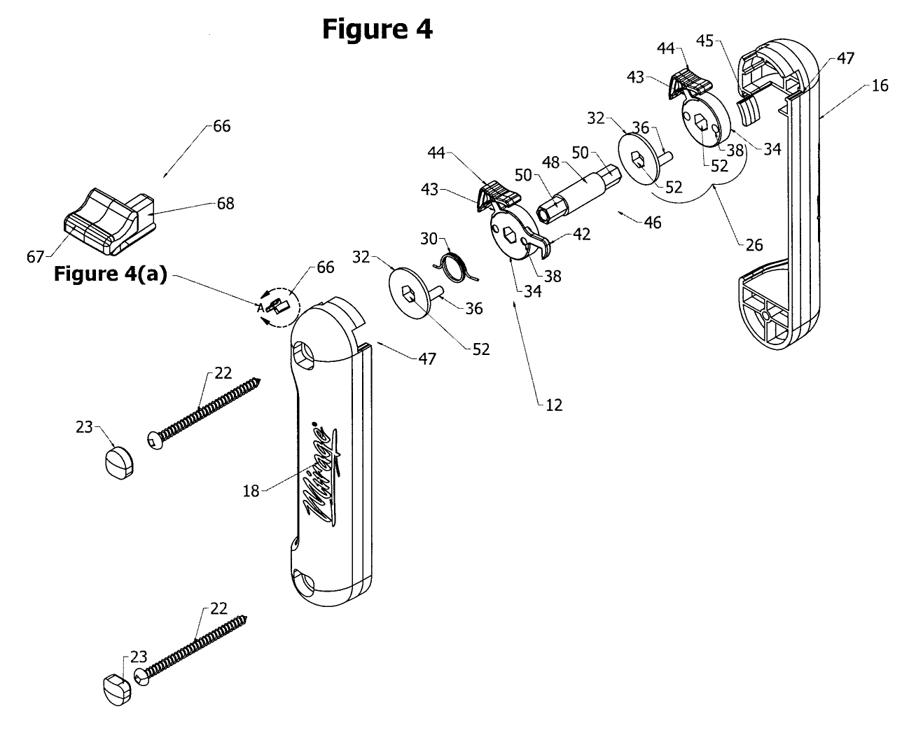

As described further below, second plate 34 may also include a hook-shaped latch 42 (FIGS. 3 and 4) and a thumb lever 44 for activating rotation of cassette 26 against the bias of spring 30. As shown best in FIG. 8, one of cassettes 26 may comprise a second plate 34 having a lever 44 but no spring 30 or latch 42. Each lever 44 is connected to a respective second plate 34 with a projecting post 43. In one embodiment of the invention, plate 34, post 43 and lever 44 (and optionally latch 42) may be one integral component part.

The pair of cassettes 26 are coupled together with a connector shaft 46, as shown best in FIG. 8. In the illustrated embodiment, shaft 46 includes a central portion 48 and two hexagonal-shaped end portions 50 which are each shaped to be received within mating apertures 52 formed in central portions of plates 32, 34. As will be apparent to a person skilled in the art, the size and shape of end portions 50 and apertures 52 may vary without departing from the invention. As shown best in FIGS. 2-4 and 12, upper fastener 22 functioning as the axle for latch subassembly 12 extends through the interior of connector shaft 46 and apertures 52. Connector shaft 46 ensures that rotational movement of one cassette 26 relative to a respective handle 16, 18 will be translated to the other cassette 26 of latch subassembly 12. Thus rotational movement of latch 42 may be actuated from either side of door 20. Since cassettes 26 are interchangeable, this allows latch 42 to be located on the right side, left side, inside or outside of the door screen depending upon user or installer preference.

As shown in the drawings, each handle 16, 18 has first and/or second slot openings 47 for receiving a respective thumb lever 44 and latch 42. In some configurations a handle opening 47 may be filled with a plug 45. For example, a plug 45 can remain in place if the handle 16, 18 receives a cassette 26 which does not include a second plate 34 bearing a latch 42.

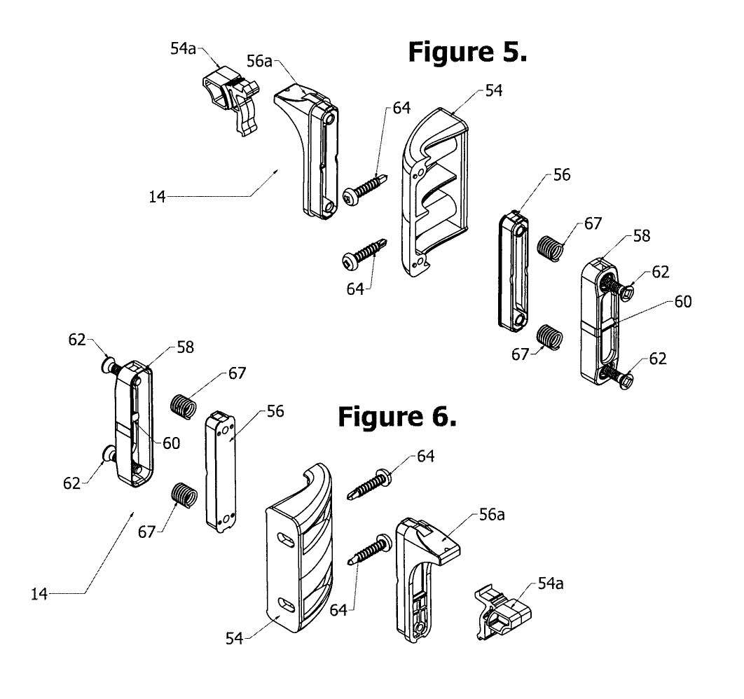

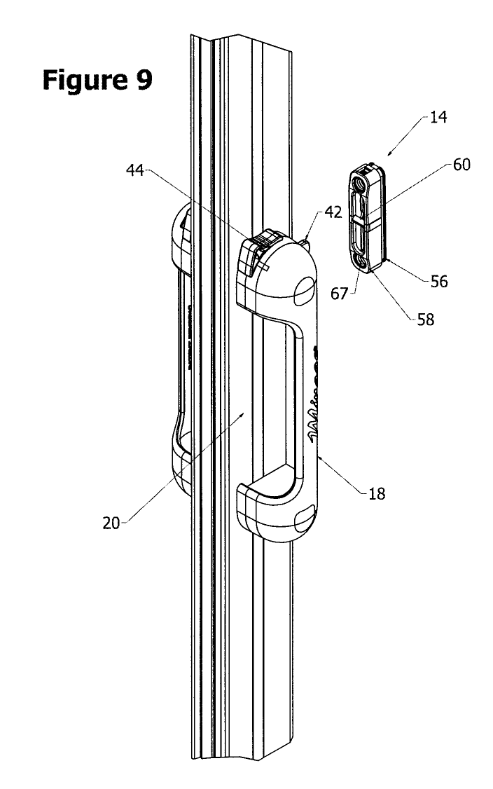

Latch 42 is adjustable between engaged and disengaged positions when door 20 is in the extended position. As shown in FIG. 9, when door 20 is fully extended, latch 42 may latchingly engage catch subassembly 14. As described further below, catch subassembly 14 may be mounted on a support surface such as a door jamb or pocket door frame or another door in a French door application. In one embodiment of the invention, catch subassembly 14 includes a bracket 54 for receiving a catch base 56 and a catch cover 58. Catch cover 58 includes a catch bar 60 for releasably engaging latch 42. In one embodiment of the invention base 56 and cover 58 may be configured to snap together. Fasteners 62 may also be provided to aid in coupling base 56 and cover 58 to a bracket 54 or other support surface, as shown in FIGS. 5 and 6. Additional fasteners 64 may be used for mounting bracket 54 on a support surface, such as a door jamb, at the desired location. Optionally, a pair of springs 67 may be disposed between base 56 and cover 58 for biasing cover 58 outwardly. Thus the exact position of catch bar 60 relative to base 56 may be finely adjusted by turning fasteners 62.

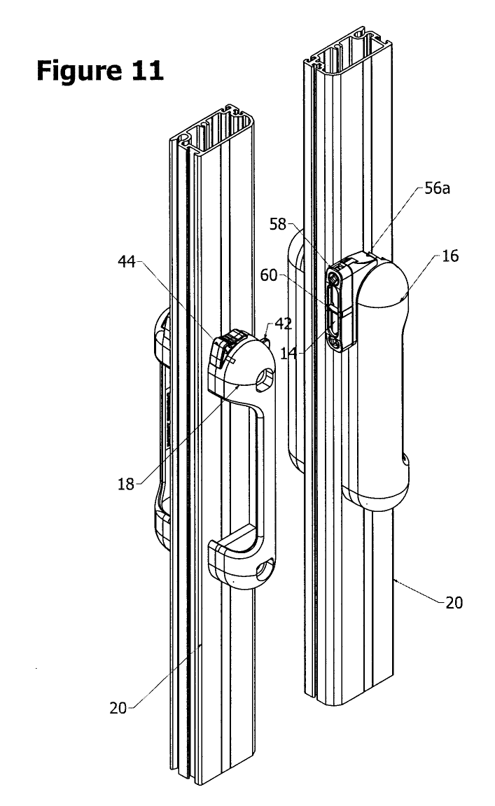

As will be apparent to a person skilled in the art, catch subassembly 14 may be mounted in many different configurations and orientations. For example, subassembly 14 may be mounted on an outer or inner surface of a door jamb (FIG. 10) using bracket 54 and fasteners 64. In the case of some applications, such as the frame of a pocket door, bracket 54 may not be required (FIG. 9) and base 56 and attached cover 58 may be mounted directly on the support surface. In the case of a sliding French door application, bracket 54 and base 56 may be replaced with a modified bracket 54a and base 56a for coupling the latch subassembly to a door handle 16, 18 (FIGS. 5, 6 and 11). Thus the shape and orientation of the component parts of catch subassembly 14 may vary depending upon the application.

As shown best in FIGS. 4 and 4a, latch subassembly 12 may further include a safety catch 66 for maintaining latch 42 in the engaged position. Catch 66 may include a thumb slide 67 and a tab 68 which releasably engages a lever 44 of an adjacent cassette 26 (e.g. by blocking movement of lever post 43) and hence constrains rotational movement of cassettes 26 and latch 42. Each handle 16, 18 includes a small, scored knock-out panel 69 for exposing a slot for slidably receiving catch 66 (FIGS. 2 and 3). For example, panel 69 may be removed by an installer using a utility knife and needle nose pliers. Catch 66 may be mounted to optionally engage the cassette 26 comprising latch 42 or the opposite cassette 26. Thus, in one configuration, latch 42 may be disposed on an outer side of a door 20 and catch 66 may be disposed on an inner side of a door 20. Safety catch 66 is optionally provided to offer users a measure of security, but it is not intended to function as robust lock preventing forceful opening of door 20.

In use, latch subassembly 12 and catch subassembly 14 are assembled in the desired configuration as described above and illustrated in the drawings. When retractable door 20 is moved by a user toward its fully extended position (FIG. 9), latch 42 of latch subassembly 12 rides up and engages bar 60 of catch subassembly 14 (i.e. latch subassembly 12 is self-latching). Optionally, latch 42 may be maintained in the engaged position by sliding catch 66 to its catched position to restrain rotation of cassettes 26. Door 20 may be opened by sliding catch 66 to the disengaged position and depressing a thumb lever 44 (from either side of door 20) against the bias of spring 30 to raise latch 42 away from bar 60. This disengages latch 42 and allows the user to return door 20 to its retracted position.

As explained above, latch assembly 10 is sufficiently versatile to suit both single door and French door applications. Since cassettes 26 are interchangeable, latch 42 may be optionally located on the right side, left side, inside or outside of the screen door depending upon user or installer preference. Moreover, safety catch 66 may be disposed on either the same side as latch 42 or the opposite side of the door 20. The ability to install latch assembly 10 in many different combinations and permutations is an important feature of the present invention.

Although mechanical latch assembly 10 has been described above in respect of a retractable screen door application, it should be apparent to a person skilled in the art that the same mechanism can be used in regard to retractable windows or other screened or non-screened closures.

While a number of exemplary aspects and embodiments have been discussed above, those of skill in the art will recognize certain modifications, permutations, additions and sub-combinations thereof. It is therefore intended that the following appended claims of the invention and claims hereafter introduced are interpreted to include all such modifications, permutations, additions and sub-combinations as are within their true spirit and scope.

We claim:

1. A latch assembly for a retractable door or window closure, said closure having a first handle and a second handle disposed on opposite sides of said closure for moving said closure between retracted and extended positions, said latch assembly comprising;
(a) a latch subassembly disposed between said first and second handles, said latch subassembly comprising (i) a latch disposed on a rotatable cassette, and (ii) at least one lever for actuating rotation of said cassette to move said latch between an engaged and a disengaged position; and
(b) a catch subassembly mountable on a support surface for releasably engaging said latch when said closure is in said extended position and said latch is moved to said engaged position.

2. The assembly as defined in claim 1, wherein said latch subassembly comprises a spring for biasing said latch toward said engaged position.

3. The assembly as defined in claim 1, wherein said lever comprises a thumb tab projecting from said cassette for manually actuating rotation of said cassette.

4. The assembly as defined in claim 3, wherein said latch subassembly comprises a safety catch for releasably maintaining said latch in said engaged position.

5. The assembly as defined in claim 4, wherein said catch comprises a pin for releasably engaging said lever to constrain movement of said cassette.

6. The latch assembly of claim 1, wherein said at least one cassette comprises a first cassette disposed within said first handle and a second cassette disposed within said second handle, whereby activation of said latch between said engaged and disengaged positions may be activated by rotating said first or second cassettes from either side of said door.

7. The latch assembly of claim 1, wherein said catch subassembly comprises a base mountable on said support surface and a cover adjustably connectable to said base, said cover comprising a catch for receiving said latch.

8. The latch assembly of claim 7, wherein said catch subassembly comprises a bracket for mounting said base to a support surface.

9. The latch assembly as defined in claim 7, comprising springs disposed between said base and said cover for biasing said cover outwardly.

10. The latch assembly of claim 6, comprising a connector shaft extending between said handles for operably coupling said first and second cassettes together.

11. The latch assembly of claim 2, wherein said spring is mounted on said cassette.

12. The latch assembly of claim 10, wherein each of said first and second cassettes comprises first and second annular plates coupled to said connector shaft.
